(19) United States
(12) Patent Application Publication
(10) Pub. No.: US 2016/0156069 A1
(43) Pub. Date: Jun. 2, 2016

(54) SODIUM MOLTEN SALT BATTERY

(71) Applicant: SUMITOMO ELECTRIC INDUSTRIES, LTD., Osaka (JP)

(72) Inventors: Shoichiro SAKAI, Osaka-shi (JP); Koji NITTA, Osaka-shi (JP); Atsushi FUKUNAGA, Osaka-shi (JP); Koma NUMATA, Osaka-shi (JP); Eiko IMAZAKI, Osaka-shi (JP)

(21) Appl. No.: 14/906,843

(22) PCT Filed: May 23, 2014
(86) PCT No.: PCT/JP2014/063692

§ 371 Date: Jan. 21, 2016

(30) Foreign Application Priority Data
Jul. 26, 2013 (JP) 2013-156004

(51) Int. Cl. H01M 10/39; H01M 4/505; H01M 4/525; H01M 4/485

(52) U.S. Cl. CPC H01M 10/399; H01M 4/485; H01M 4/505; H01M 4/525; H01M 2300/0048; H01M 2220/20

(57) ABSTRACT

The sodium molten salt battery includes a positive electrode containing a positive electrode active material, a negative electrode containing a negative electrode active material, a separator arranged between the positive electrode and the negative electrode, and a molten salt electrolyte having sodium ion conductivity, in which the positive electrode active material contains a sodium-containing transition metal oxide, the negative electrode active material contains hard carbon, and the ratio of the reversible capacity Cₙ of the negative electrode to the reversible capacity Cₚ of the positive electrode, i.e., Cₙ/Cₚ, is 0.86 to 1.2.

### TECHNICAL FIELD

The present invention relates to a sodium molten salt battery.

### BACKGROUND ART

In recent years, techniques for converting natural energy, such as sunlight and wind power, into electrical energy have been receiving attention. There has been increasing demand for nonaqueous electrolyte secondary batteries as high-energy-density batteries capable of storing a large amount of electrical energy. Among nonaqueous electrolyte secondary batteries, lithium-ion secondary batteries have the advantage of being light in weight and having high electromotive forces.

In lithium-ion secondary batteries, positive electrodes composed of lithium transition metal oxides, such as lithium cobalt oxide, and negative electrodes composed of graphite are used. In lithium-ion secondary batteries, if capacities of negative electrodes are smaller than those of positive electrodes, metallic lithium dendrites are deposited on surfaces of negative electrodes during charging, significantly impairing safety. Thus, in lithium-ion secondary batteries, it is preferable that capacities of negative electrodes should be larger than those of positive electrodes. PTL 1 reports that the ratio of the initial capacity of a negative electrode to the initial capacity of a positive electrode is 1.0 to 2.0 from the viewpoint of inhibiting the deposition of metallic lithium and a reduction in the energy density of a lithium-ion secondary battery.

The price of lithium resources is rising in association with the expansion of the market for lithium-ion secondary batteries. Thus, there have also been advances in the development of secondary batteries including sodium, which is inexpensive rather than lithium. PTL 2 reports a sodium-ion secondary battery including a positive electrode containing a sodium-containing phosphate compound, a negative electrode containing a sodium-containing phosphate compound or a carbonaceous material, and an organic electrolytic solution. In PTL 2, in the case where the positive electrode composed of Na₃V₂(PO₄)₂F₃ and the negative electrode composed of carbon are used, the theoretical capacity ratio of the positive electrode to the negative electrode is adjusted to positive electrode:negative electrode=1:3.

In lithium-ion secondary batteries and sodium-ion secondary batteries, organic electrolytic solutions containing organic solvents are used. Thus, the heat resistance is low, and electrolytes are easily decomposed on surfaces of electrodes. There have been advances in the development of molten salt batteries including flame-retardant molten salts serving as electrolytes. Molten salts have excellent thermal stability, relatively easily ensure safety, and are also suited for continuous use at high temperatures. A molten salt battery can include a molten salt which contains inexpensive sodium ions and which is used as an electrolyte, so that the production cost is low.

### CITATION LIST

### Patent Literature

PTL 1: Japanese Unexamined Patent Application Publication No. 2012-243477

PTL 2: Japanese Unexamined Patent Application Publication No. 2013-89391

### SUMMARY OF INVENTION

### Technical Problem

In PTL 1 regarding a lithium-ion secondary battery, graphite is used as a negative electrode active material. In lithium-ion secondary batteries, metallic lithium dendrites can be deposited on surfaces of negative electrodes at the time of overcharge to impair the safety of batteries. Thus, it is preferred that capacities of positive electrodes should be smaller than capacities of negative electrodes.

However, the appropriate capacity ratio of a positive electrode to a negative electrode significantly varies depending on the type of active material and the type of electrolyte used in a battery. For example, in PTL 1, the ratio of the initial capacity of the negative electrode to the initial capacity of the positive electrode is 1 to 2. PTL 1 states that a higher initial capacity ratio reduces the energy density. In PTL 2 that discloses the sodium-ion secondary battery, in the case where a carbonaceous material is used as a negative electrode active material, the ratio of the theoretical capacity of the negative electrode to the theoretical capacity of the positive electrode is adjusted to 3. Thus, in the case where the ratio of the theoretical capacity (or the initial capacity) of the negative electrode to the positive electrode in each battery is used for another battery, it is unclear that the same effect is provided. In a lithium-ion secondary battery, the shortage of a negative electrode capacity causes the deposition of metallic lithium dendrites. The detachment of the metallic lithium dendrites reduces the capacity and causes difficulty in ensuring safety. Thus, usually, the ratio of the reversible capacity of a negative electrode to the reversible capacity of a positive electrode is larger than 1.2.

In a molten salt battery including a molten salt electrolyte having sodium ion conductivity (sodium molten salt battery), hard carbon is used as a negative electrode active material. The hard carbon has a high reversible capacity, compared with graphite used as a negative electrode active material in the lithium-ion secondary battery in PTL 1. Thus, an inappropriate capacity ratio of the negative electrode to the positive electrode does not easily result in a high-capacity battery.

At an inappropriate capacity ratio of the negative electrode to the positive electrode, in a sodium molten salt battery, metallic sodium can be deposited on a surface of the negative electrode. When the deposited metallic sodium is detached, the battery capacity is reduced.

Thus, a sodium molten salt battery having a high battery capacity and excellent cycle characteristics is provided.

### Solution to Problem

An aspect of the present invention relates to a sodium molten salt battery including a positive electrode containing a positive electrode active material, a negative electrode containing a negative electrode active material, a separator arranged between the positive electrode and the negative electrode, and a molten salt electrolyte having sodium ion conductivity, in which the positive electrode active material contains a sodium-containing transition metal oxide, the negative electrode active material contains hard carbon, and the ratio of the reversible capacity Cₙ of the negative electrode to the reversible capacity Cₚ of the positive electrode, i.e., Cₙ/Cₚ, is 0.86 to 1.2.

### Advantageous Effects of Invention

According to the foregoing aspect of the present invention, the sodium molten salt battery has an improved battery capacity and excellent cycle characteristics even though the hard carbon is used as the negative electrode.

### BRIEF DESCRIPTION OF DRAWINGS

FIG. 1 is a longitudinal sectional view schematically illustrating a sodium molten salt battery according to an embodiment of the present invention.

FIG. 2 is a graph illustrating the relationship between the number of charge-discharge cycles for sodium molten salt batteries in examples and comparative examples and the battery capacity per unit weight of a positive electrode active material.

### DESCRIPTION OF EMBODIMENTS

### Description of Embodiments of Invention

First, embodiments of the present invention will be listed and described below.

An embodiment of the present invention relates to (1) a sodium molten salt battery including a positive electrode containing a positive electrode active material, a negative electrode containing a negative electrode active material, a separator arranged between the positive electrode and the negative electrode, and a molten salt electrolyte having sodium ion conductivity, in which the positive electrode active material contains a sodium-containing transition metal oxide, the negative electrode active material contains hard carbon, and the ratio of the reversible capacity Cₙ of the negative electrode to the reversible capacity Cₚ of the positive electrode, i.e., Cₙ/Cₚ, is 0.86 to 1.2.

The hard carbon exhibits only a small change in volume due to charging and discharging and is less likely to degrade, thereby extending the cycle life. However, when the hard carbon is used for a negative electrode, the voltage (or capacity) of the battery is not stable. In the case where the hard carbon is used as a negative electrode active material, the voltage or capacity of the battery need to be stabilized with peripheral equipment, thereby leading to high cost. For this reason, substantially no negative electrode containing hard carbon serving as a negative electrode active material is practically used in lithium-ion secondary batteries.

In sodium molten salt batteries, hard carbon is used as a negative electrode active material. However, hard carbon has a high reversible capacity, compared with graphite used as a negative electrode active material in lithium-ion secondary batteries. Thus, when hard carbon is used for negative electrodes, it is difficult to produce high-capacity batteries. The shortage of negative electrode capacities can cause the deposition of metallic sodium on surfaces of negative electrodes in sodium molten salt batteries. When the deposited metallic sodium is detached, capacities of batteries are reduced. Thus, also in the case of a sodium molten salt battery, as with a lithium-ion secondary battery, it is presumed that the ratio of the reversible capacity of a negative electrode to the reversible capacity of a positive electrode needs to be larger than 1.2. However, in fact, the reversible capacity ratio, Cₙ/Cₚ, of the negative electrode to the positive electrode needs to be controlled to 0.86 to 1.2. In this case, the capacity balance between the positive electrode and the negative electrode is enhanced to inhibit the deposition of metallic sodium and inhibit an excessive increase in the irreversible capacity of the hard carbon. Thus, the capacity of the sodium molten salt battery is increased even though the hard carbon is used for the negative electrode.

In a sodium molten salt battery, even if metallic sodium is deposited, the metallic sodium is in the form of particles, and the operating temperature of the battery can be high, compared with secondary batteries, such as lithium-ion secondary batteries, including organic electrolytic solutions. In other words, the behavior of a change in the capacity of the battery due to the deposition of metallic deposits is different from the case of lithium-ion secondary batteries. For this reason, it is presumed that means for inhibiting a reduction in the capacity of a lithium-ion secondary battery cannot be directly used for a sodium molten salt battery. In the foregoing embodiment of the present invention, by controlling the reversible capacity ratio, Cₙ/Cₚ, of the negative electrode to the positive electrode to 0.86 to 1.2, the deposition of metallic sodium particles is inhibited, thereby maintaining a high capacity even when charging and discharging are repeated (that is, the cycle characteristics are improved). The reason the effect is provided at the reversible capacity ratio is presumably that the deposition state of the metal deposited on the negative electrode during charging and/or the battery operating temperature of the sodium molten salt battery is different from a lithium-ion secondary battery, so that the behavior of the change in the capacity of the battery due to the deposition of the metal deposits is different.

The molten salt battery used here indicates a generic name of a battery containing a molten salt (a salt in a molten state (ionic liquid)) that serves as an electrolyte. The molten salt electrolyte indicates an electrolyte containing a molten salt. The sodium molten salt battery indicates a battery which includes a molten salt exhibiting sodium ion conductivity as an electrolyte and in which sodium ions serve as charge carriers participating in a charge-discharge reaction. The ionic liquid indicates a liquid consisting of an anion and a cation.

(2) The molten salt electrolyte preferably contains an ionic liquid in an amount of 80% by mass or more. In this case, the molten salt electrolyte has high heat resistance and/or flame retardancy. Thus, even if the operating temperature of the battery is high, it is possible to more stably operate the battery.

(3) The sodium-containing transition metal oxide is preferably a compound represented by the formula (A):

Na₁₋ₓ₁M¹ₓ₁Cr_{1-y1}M²_{y1}O₂ (A)

(wherein in the formula, M¹ and M² each independently represent at least one selected from the group consisting of Ni, Co, Mn, Fe, and Al, and x1 and y1 satisfy 0≦x1≦⅔ and 0≦y1≦⅔, respectively), or (4) the sodium-containing transition metal oxide is preferably sodium chromite. The use of such a compound as the sodium-containing transition metal oxide enables sodium ions to be relatively stably occluded and released and facilitates an increase in the capacity of the positive electrode. Furthermore, such a compound has excellent thermal stability and electrochemical stability.

(5) The average interplanar spacing d₀₀₂ of the (002) planes of the hard carbon measured from an X-ray diffraction spectrum is preferably 0.37 to 0.42 nm. The hard carbon having the average interplanar spacing d₀₀₂ exhibits only a small change in volume due to the occlusion and release of sodium ions during charging and discharging. Thus, even when charging and discharging are repeated, the degradation of the positive electrode active material is inhibited, thereby easily improving the cycle characteristics.

In a preferred embodiment, (6) the molten salt electrolyte contains a first salt of a first cation and a firs anion, in which the first cation is a sodium cation, and the first anion is a bis(sulfonyl)amide anion. The molten salt electrolyte has sodium ion conductivity and enables the battery to be operated at a relatively low temperature.

(7) In (6) described above, preferably, the molten salt electrolyte further contains a second salt of a second cation and a second anion, in which the second cation is a cation other than a sodium ion, and the second anion is a bis(sulfonyl)amide anion. In the case where the molten salt electrolyte contains the second salt in addition to the first salt, the melting point of the molten salt electrolyte is reduced, thereby further reducing the operating temperature of the battery.

(8) In (7) described above, more preferably, the second cation is an organic cation. In the case of the molten salt electrolyte containing the second cation, the melting point is easily reduced. Furthermore, setting the reversible capacity ratio, Cₙ/Cₚ, to the specific range described above inhibits a reduction in negative electrode capacity, thereby stabilizing the cycle characteristics.

### Details of Embodiments of Invention

Specific examples of a sodium molten salt battery according to embodiments of the present invention will be described below with appropriate reference to the drawings. The present invention is not limited to these examples. The present invention is indicated by the appended claims. It is intended to include any modifications within the scope and meaning equivalent to the scope of the claims.

### (Positive Electrode)

The positive electrode contains a positive electrode active material containing a sodium-containing transition metal oxide. Specifically, the positive electrode may include a positive electrode current collector and a positive electrode mixture (or a positive electrode mixture layer) fixed on the positive electrode current collector, the positive electrode mixture containing a positive electrode active material. The positive electrode may include, for example, a binder and a conductive assistant, as optional components. Preferably, the positive electrode active material electrochemically occludes and releases sodium ions.

As the positive electrode current collector, metal foil, a nonwoven fabric composed of metal fibers, a porous metal sheet, or the like is used. Examples of a metal preferably contained in the positive electrode current collector include, but are not limited to, aluminum and aluminum alloys because they are stable at a positive electrode potential.

The metal foil serving as the positive electrode current collector has a thickness of, for example, 10 to 50 μm. Each of the non-woven fabric composed of metal fibers and the porous metal sheet has a thickness of, for example, 100 to 1000 μm.

The sodium-containing transition metal oxide used as a positive electrode active material has excellent thermal stability and electrochemical stability. Preferably, the sodium-containing transition metal oxide has, but not particularly limited to, a layered crystal structure, in which sodium ions are intercalated into and deintercalated from the interlayer portions of the layered structure.

The sodium-containing transition metal oxide may contain a transition metal in addition to sodium. At least one of sodium and the transition metal may be partially replaced with a main-group metal element. Examples of the transition metal include transition metals, such as Cr, Mn, Fe, Co, and Ni, in the fourth period of the periodic table. Examples of the main-group metal element include main-group metal elements, such as Zn, Al, In, Sn, and Sb, in the twelfth to fifteenth groups of the periodic table. The sodium-containing transition metal oxide may contain one or two or more transition metals and one or two or more main-group metal elements.

Examples of the oxide include chromium-containing oxides, such as NaCrO₂; iron-containing oxides, such as NaFeO₂, NaFe_{z}(Ni_{0.5}Mn_{0.5})_{1-z}O₂ (0<z<1), and Na_{2/3}Fe_{1/3}Mn_{2/3}O₂; oxides containing nickel and/or manganese, such as NaNiO₂, NaMnO₂, Na_{0.44}MnO₂, NaNi_{0.5}Mn_{0.5}O₂, and NaMn_{1.5}Ni_{0.5}O₄; and cobalt-containing oxides, such as NaCoO₂. These sodium-containing transition metal oxides may be used separately or in combination of two or more.

Among the sodium-containing transition metal oxides, an oxide containing chromium in addition to sodium is preferred. Examples of the oxide include a compound represented by the following formula A:

Na₁₋ₓ₁M¹ₓ₁Cr_{1-y1}M²_{y1}O₂ (A)

(wherein in the formula, M¹ and M² each independently represent a metal element other than Cr or Na, x1 and y1 satisfy 0≦x1≦⅔ and 0≦y≦⅔, respectively).

In the formula (A), M¹ represents an element that occupies Na sites, and M² represents an element that occupies Cr sites. Examples of the metal elements represented by the metal elements M¹ and M² include the transition metal elements exemplified above and the main-group elements exemplified above. The metal element M¹ and the metal element M² may be the same or different. Preferably, the metal elements represented by the metal elements M¹ and M² each independently are at least one selected from the group consisting of Mn, Fe, Co, Ni, and Al. x1 is preferably 0≦x1≦0.5 and more preferably 0≦x1≦0.3. y1 is preferably 0≦y1≦0.5 and more preferably 0≦y1≦0.3. In such a compound, a stable layered crystal structure is easily obtained. Thus, relatively smooth occlusion and release of sodium ions are easily performed, thereby facilitating a reduction in the irreversible capacity of the positive electrode.

Among the compounds represented by the formula (A), in particular, sodium chromite NaCrO₂ is preferred. Regarding the positive electrode active material, such as sodium chromite, the proportion of Na is changed by a charge-discharge reaction, in some cases. In the case where such a positive electrode active material is used, the reversible capacity of the positive electrode may be determined in light of the change in the proportion of Na. For example, the reversible capacity of the positive electrode containing sodium chromite Na₁₋ₓCrO₂ serving as a positive electrode active material is a capacity on the assumption that the proportion of Na varies in the range of 0≦x≦0.5. When x is more than 0.5, the crystal structure of sodium chromite is changed, so that it is impossible to reversibly intercalate and deintercalate sodium ions.

The positive electrode active material is not particularly limited as long as it contains the sodium-containing transition metal oxide. The positive electrode active material may contain a material other than the sodium-containing transition metal oxide, the material reversibly occluding and releasing sodium ions. Examples of the material include other transition metal compounds. Specific examples thereof include sulfides (such as TiS₂, FeS₂, and NaTiS₂), sodium-containing transition metal silicates (such as Na₆Fe₂Si₁₂O₃₀, Na₂Fe₅Si₁₂O₃₀, Na₂Fe₂Si₆O₁₈, Na₂MnFeSi₆O₁₈, and Na₂FeSiO₆), sodium- containing transition metal phosphates, sodium-containing transition metal fluorophosphates (such as Na₂FePO₄F and NaVPO₄F), and sodium transition metal borates (such as NaFeBO₄ and Na₃Fe₂(BO₄)₃). The content of the sodium-containing transition metal oxide in the positive electrode active material is, for example, 90% by mass or more and preferably 95% by mass or more. As the positive electrode active material, the sodium-containing transition metal oxide is preferably used alone.

The positive electrode (specifically, the positive electrode mixture) may contain a binder, a conductive assistant, and so forth as optional components, in addition to the positive electrode active material.

The binder serves to bond the active material particles together and fix the active material to the current collector. Examples of the binder include fluororesins, such as polytetrafluoroethylene, tetrafluoroethylene-hexafluoropropylene copolymers, and polyvinylidene fluoride; polyamide resins, such as aromatic polyamide; polyimide resins, such as polyimide (e.g., aromatic polyimide) and polyamide-imide; rubbery polymers, such as styrene rubber, e.g., styrene-butadiene rubber (SBR), and butadiene rubber; and cellulose derivatives (e.g., cellulose ethers), such as carboxymethylcellulose (CMC) and salts thereof (e.g., Na salts).

The amount of the binder is preferably 1 to 10 parts by mass and more preferably 3 to 5 parts by mass with respect to 100 parts by mass of the active material.

Examples of the conductive assistant include carbonaceous conductive assistants, such as carbon black and carbon fibers; and metal fibers. The amount of the conductive assistant may be appropriately selected from, for example, 0.1 to 15 parts by mass with respect to 100 parts by mass of the active material and may be in the range of 0.3 to 10 parts by mass.

The positive electrode may be formed by fixing the positive electrode mixture to a surface of the positive electrode current collector. Specifically, the positive electrode may be formed by, for example, a positive electrode mixture paste containing the positive electrode active material to the surface of the positive electrode current collector, drying the paste, and optionally rolling the paste.

The positive electrode mixture paste is prepared by dispersing the positive electrode active material and, as optional components, the binder and the conductive assistant in a dispersion medium. Examples of the dispersion medium include ketones, such as acetone; ethers, such as tetrahydrofuran; nitriles, such as acetonitrile; amides, such as dimethylacetamide; and N-methyl-2-pyrrolidone. These dispersion media may be used separately or in combination of two or more thereof.

### (Negative Electrode)

The negative electrode contains a negative electrode active material containing hard carbon. Specifically, the negative electrode may include a negative electrode current collector and a negative electrode mixture (or a negative electrode mixture layer) which is fixed to the negative electrode current collector and which contains the negative electrode active material.

As with the positive electrode current collector, metal foil, a nonwoven fabric composed of metal fibers, a porous metal sheet, and so forth are used as the negative electrode current collector. Examples of a metal preferably contained in the negative electrode current collector include, but are not limited to, copper, copper alloys, nickel, nickel alloys, aluminum, and aluminum alloys because they are not alloyed with sodium and are stable at a negative electrode potential. The thickness of the negative electrode current collector may be selected from the same range as in the positive electrode current collector.

Unlike graphite, which has a graphite crystal structure in which carbon layer planes are stacked in layers, hard carbon, serving as a negative electrode active material, has a turbostratic structure in which carbon layer planes are stacked in a state of being three-dimensionally displaced. The heat treatment of hard carbon even at a high temperature (e.g., 3000° C.) does not result in a transformation from the turbostratic structure to the graphitic structure or the development of graphite crystallites. Thus, hard carbon is also referred to as non-graphitizable carbon.

The average interplanar spacing d₀₀₂ of the (002) planes of a carbonaceous material measured from an X-ray diffraction (XRD) spectrum is used as an index to the degree of development of a graphite crystal structure of the carbonaceous material. The carbonaceous material categorized into graphite typically has a small average interplanar spacing d₀₀₂ less than 0.337 nm. In contrast, the hard carbon with the turbostratic structure has a large average interplanar spacing d₀₀₂ of, for example, 0.37 nm or more and preferably 0.38 nm or more. The upper limit of the average interplanar spacing d₀₀₂ of the hard carbon is not particularly limited. The average interplanar spacing d₀₀₂ may be, for example, 0.42 nm or less or 0.4 nm or less. These lower and upper limits may be freely combined. The hard carbon may have an average interplanar spacing d₀₀₂ of, for example, 0.37 to 0.42 nm and preferably 0.38 to 0.4 nm.

In lithium-ion secondary batteries, graphite is used for negative electrodes. Lithium ions are intercalated into interlayer portions of the graphite crystal structure in graphite (specifically, the layered structure of carbon layer planes (what is called a graphene structure)). The hard carbon has the turbostratic structure. The proportion of the graphite crystal structure in the hard carbon is small. In the case where sodium ions are occluded in the hard carbon, sodium ions enter the turbostratic structure of the hard carbon (specifically, portions other than interlayer portions of the graphite crystal structure) and are adsorbed on the hard carbon, so that sodium ions are occluded in the hard carbon. Examples of the portions other than the interlayer portions of the graphite crystal structure include voids (or pores) formed in the turbostratic structure.

In lithium-ion secondary batteries, many lithium ions are intercalated into and deintercalated from interlayer portions of the layered structure of graphite during charging and discharging. In addition, the proportion of a layered structure is large. Thus, a change in the volume of an active material due to charging and discharging is large. The repetition of charging and discharging significantly degrades the active material. In sodium molten salt batteries, sodium ions are inserted into and released from the voids and so forth in the turbostratic structure. Thus, a stress caused by the insertion and release of sodium ions is relieved to reduce a change in volume, thus inhibiting the degradation even if the charging and discharging are repeated.

Regarding the structure of hard carbon, various models have been reported. It is considered that in the turbostratic structure, carbon layer planes are stacked in a state of being three-dimensionally displaced to form voids as described above. Thus, the hard carbon has a low average specific gravity, compared with graphite having a crystal structure in which carbon layer planes are densely stacked in layers. Graphite has an average specific gravity of about 2.1 to about 2.25 g/cm³. The hard carbon has an average specific gravity of, for example, 1.7 g/cm³ or less and preferably 1.4 to 1.7 g/cm³ or 1.5 to 1.7 g/cm³. The average specific gravity of the hard carbon leads to only a small change in volume due to the occlusion and release of sodium ions during charging and discharging, thus effectively inhibiting the degradation of the active material.

The hard carbon has an average particle size (a particle size at a cumulative volume of 50% in the volume particle size distribution) of, for example, 3 to 20 μm and preferably 5 to 15 μm. In the case where the average particle size is within the range described above, the filling properties of the negative electrode active material in the negative electrode is easily improved.

The hard carbon contains a carbonaceous material obtained by, for example, carbonization of a raw material in a solid state. The raw material subjected to carbonization in the solid state is a solid organic substance. Specific examples thereof include saccharides and resins (thermosetting resins, such as phenolic resins, and thermoplastic resins, such as polyvinylidene chloride). Examples of saccharides include saccharides having relatively short carbohydrate chains (monosaccharides, such as sucrose); and polysaccharides, such as cellulose [for example, cellulose and derivatives thereof (cellulose esters, cellulose ethers, and so forth), and cellulose-containing materials, such as wood and fruit shells (coconut shells and so forth)]. Glassy carbon is also included in the hard carbon. A single type of hard carbon may be used alone. Two or more types of hard carbon may be used in combination.

The negative electrode active material is not particularly limited as long as it contains the hard carbon. The negative electrode active material may contain a material which is other than the hard carbon and which reversibly occludes and release sodium ions. The negative electrode active material has a hard carbon content of, for example, 90% by mass or more and preferably 95% by mass or more. It is also preferable to use the hard carbon alone as the negative electrode active material.

In a sodium molten salt battery, sodium ions that are not occluded in the negative electrode during charging may be deposited on a surface of the negative electrode in the form of metallic sodium particles. The deposition of the metallic sodium particles tends to be significant as the capacity of the negative electrode is lower than that of the positive electrode. The metallic sodium particles deposited on the surface of the negative electrode are easily detached. The detached metallic sodium particles do not participate in a charge-discharge reaction, thus reducing the battery capacity to degrade the cycle characteristics. From the viewpoint of inhibiting the deposition of metallic sodium, it is preferred that the capacity of the negative electrode should be larger than that of the positive electrode.

Since the hard carbon has a relatively large irreversible capacity, a larger negative electrode capacity results in a higher proportion of the irreversible capacity in the negative electrode capacity. This reduces the reversible capacity of the negative electrode actually participating in the charge-discharge reaction. It is thus difficult to provide a high-capacity battery.

In an embodiment of the present invention, the ratio of the reversible capacity Cₙ of the negative electrode to the reversible capacity Cₚ of the positive electrode, Cₙ/Cₚ, is 0.86 to 1.2. In the case where the reversible capacity ratio Cₙ/Cₚ is within the range described above, the capacity balance between the positive electrode and the negative electrode is improved to inhibit an excessive increase in the irreversible capacity of the negative electrode while the deposition of metallic sodium on the surface of the negative electrode is inhibited. As a result, a reduction in the capacity of the negative electrode is inhibited to improve the battery capacity and further improve the cycle characteristics.

The ratio Cₙ/Cₚ is 0.86 or more, preferably 0.88 or more, and more preferably 0.89 or more or 0.9 or more. The ratio Cₙ/Cₚ is 1.2 or less, preferably less than 1.2, more preferably 1.15 or less or 1.1 or less, and particularly preferably 1.06 or less (for example, 1.02 or less). These lower and upper limits may be freely combined. The ratio Cₙ/Cₚ may be, for example, 0.88 to 1.15, 0.9 to 1.1, or 0.9 to 1.02.

The reversible capacity ratio is smaller than those usually set in lithium-ion secondary batteries. In a lithium-ion secondary battery, in the case where the reversible capacity ratio is set to the range as described above, the deposition of metallic lithium is significant, and a reduction in capacity is unavoidable. The reason the effect is provided at the foregoing reversible capacity ratio in an embodiment of the present invention is presumably that the deposition state of the metal deposited on the negative electrode during charging and/or the battery operating temperature of the sodium molten salt battery is different from a lithium-ion secondary battery, so that the behavior of the change in the capacity of the battery due to the deposition of the metal deposits is different.

The binder and the conductive assistant may be appropriately selected from those exemplified for the positive electrode. The amounts of the binder and the conductive assistant with respect to the active material may also be appropriately selected from those exemplified for the positive electrode.

As with the case of the positive electrode, the negative electrode may be formed by applying a negative electrode mixture paste in which the negative electrode active material and, optionally, the binder and the conductive assistant are dispersed in a dispersion medium to a surface of the negative electrode current collector, drying the paste, and optionally rolling the paste. The dispersion medium may be appropriately selected from those exemplified for the positive electrode.

### (Separator)

The separator serves to physically isolate the positive electrode from the negative electrode to prevent an internal short-circuit. The separator is composed of a porous material. The pores are filled with the electrolyte. To achieve a cell reaction, the separator has sodium ion permeability.

As the separator, for example, a microporous membrane composed of a resin or a nonwoven fabric may be used. The separator may be formed of the microporous membrane or a nonwoven fabric layer alone, or may be formed of a multilayer component having a plurality of layers with different compositions and shapes. Examples of the multilayer component include multilayer components each having a plurality of resin porous layers with different compositions; and multilayer components each having a microporous membrane and a nonwoven fabric layer.

The material of the separator may be selected in consideration of the operating temperature of a battery. Examples of a resin contained in fibers constituting the microporous membrane and the nonwoven fabric include polyolefin resins, such as polyethylene, polypropylene, and ethylene-propylene copolymers; polyphenylene sulfide resins, such as polyphenylene sulfide and polyphenylene sulfide ketone; polyamide resins, such as aromatic polyamide resins (e.g., aramid resins); and polyimide resins. These resins may be used alone or in combination of two or more. The fibers constituting the nonwoven fabric may be inorganic fibers, such as glass fibers. The separator is preferably composed of at least one selected from the group consisting of glass fibers, polyolefin resins, polyamide resins, and polyphenylene sulfide resins.

The separator may contain an inorganic filler. Examples of the inorganic filler include ceramics, such as silica, alumina, zeolite, and titania, talc, mica, and wollastonite. The inorganic filler is preferably in the form of particles or fibers. The separator has an inorganic filler content of, for example, 10% to 90% by mass and preferably 20% to 80% by mass.

The thickness of the separator is not particularly limited and may be selected in the range of, for example, about 10 to about 300 μm. In the case where the separator is formed of a microporous membrane, the separator preferably has a thickness of 10 to 100 μm and more preferably 20 to 50 μm. In the case where the separator is formed of a nonwoven fabric, the separator preferably has a thickness of 50 to 300 μm and more preferably 100 to 250 μm.

### (Molten Salt Electrolyte)

The molten salt electrolyte contains at least sodium ions serving as carrier ions.

The molten salt electrolyte needs to have ionic conductivity and thus contains ions (cations and anions) serving as charge carriers in a charge-discharge reaction in the molten salt battery. More specifically, the molten salt electrolyte contains a salt of a cation and an anion. In an embodiment of the present invention, the molten salt electrolyte needs to have sodium ion conductivity and thus contains a salt (first salt) of a sodium ion (first cation) and an anion (first anion).

As the first anion, a bis(sulfonyl)amide anion is preferred. Examples of the bis(sulfonyl)amide anion include bis(fluorosulfonyl)amide anion [such as bis(fluorosulfonyl)amide anion (N(SO₂F)₂⁻)], a (fluorosulfonyl)(perfluoroalkylsulfonyl)amide anion [such as a (fluorosulfonyl)(trifluoromethylsulfonyl)amide anion ((FSO₂)(CF₃SO₂)N⁻)], and a bis(perfluoroalkylsulfonyl)amide anion [such as a bis(trifluoromethylsulfonyl)amide anion (N(SO₂CF₃)₂⁻) and a bis(pentafluoroethylsulfonyl)amide anion (N(SO₂C₂F₅)₂⁻)]. The number of carbon atoms of the perfluoroalkyl group is, for example, 1 to 10, preferably 1 to 8, more preferably 1 to 4, and particularly preferably 1, 2, or 3.

Examples of the first anion preferred include a bis(fluorosulfonyl)amide anion (FSA⁻); a (fluorosulfonyl)(perfluoroalkylsulfonyl)amide anion such as a (fluorosulfonyl)(trifluoromethylsulfonyl)amide anion; and bis(perfluoroalkylsulfonyl)amide anions (PFSA⁻), such as a bis(trifluoromethylsulfonyl)amide anion (TFSA⁻) and a bis(pentafluoroethylsulfonyl)amide anion. As the first salt, for example, a salt (NaFSA) of a sodium ion and FSA⁻ or a salt (NaTFSA) of a sodium ion and TFSA⁻ is particularly preferred. A single type of first salt may be used alone. Two or more types of first salts may be used in combination.

The electrolyte melts at a temperature equal to or higher than the melting point into an ionic liquid that exhibits sodium ion conductivity, thereby operating the molten salt battery. To operate the battery at an appropriate temperature in view of cost and its usage environment, the electrolyte preferably has a lower melting point. To reduce the melting point of the electrolyte, preferably, the molten salt electrolyte further contains a second salt of a cation (second cation) other than the sodium ion and an anion (second anion), in addition to the first salt.

Examples of the second cation include inorganic cations other than a sodium ion and organic cations, such as organic onium cations.

Examples of the inorganic cations include metallic cations, such as alkali metal cations other than a sodium ion (e.g., a lithium ion, a potassium ion, a rubidium ion, and a cesium ion), and alkaline-earth metal cations (e.g., a magnesium ion and a calcium ion); and ammonium cations.

Examples of organic onium cations include cations derived from aliphatic amines, alicyclic amines, and aromatic amines (such as quaternary ammonium cations); nitrogen-containing onium cations, such as cations having nitrogen-containing heterocycles (i.e., cations derived from cyclic amines); sulfur-containing onium cations; and phosphorus-containing onium cations.

Examples of quaternary ammonium cations include tetraalkylammonium cations (e.g., tetraC₁₋₁₀alkylammonium cations), such as a tetramethylammonium cation, a tetraethylammonium cation (TEA⁺), a hexyltrimethylammonium cation, an ethyltrimethylammonium cation, a methyltriethylammonium cation (TEMA⁺).

Examples of sulfur-containing onium cations include tertiary sulfonium cations, such as trialkylsulfonium cations (for example, triC₁₋₁₀alkylsulfonium cations), e.g., a trimethylsulfonium cation, a trihexylsulfonium cation, and a dibutylethylsulfonium cation.

Examples of phosphorus-containing onium cations include quaternary phosphonium cations, such as tetraalkylphosphonium cations (for example, tetraC₁₋₁₀alkylphosphonium cations), e.g., a tetramethylphosphonium cation, a tetramethylphosphonium cation, and a tetraoctylphosphonium cation; and alkyl(alkoxyalkyl)phosphonium cations (for example, triC₁₋₁₀alkyl(C₁₋₁₀alkoxyC₁₋₁₀alkyl)phosphonium cations), such as a triethyl(methoxymethyl)phosphonium cation, a diethylmethyl(methoxymethyl)phosphonium cation, and a trihexyl(methoxyethyl)phosphonium cation. In an alkyl(alkoxyalkyl)phosphonium cation, the total number of the alkyl groups and the alkoxyalkyl groups attached to a phosphorus atom is 4. The number of the alkoxyalkyl groups is preferably 1 or 2.

The number of carbon atoms of an alkyl group attached to the nitrogen atom of a quaternary ammonium cation, the sulfur atom of a tertiary sulfonium cation, or the phosphorus atom of a quaternary phosphonium cation is preferably 1 to 8, more preferably 1 to 4, and particularly preferably 1, 2, or 3.

Examples of the nitrogen-containing heterocyclic skeleton of an organic onium cation include 5- to 8-membered heterocycles, such as pyrrolidine, imidazoline, imidazole, pyridine, and piperidine, each having 1 or 2 nitrogen atoms serving as constituent atoms of the ring; and 5- to 8-membered heterocycles, such as morpholine, each having 1 or 2 nitrogen atoms and another heteroatom (an oxygen atom, a sulfur atom, or the like) serving as constituent atoms of the ring.

The nitrogen atom serving as a constituent atom of the ring may be attached to an organic group, such as an alkyl group, serving as a substituent. Examples of the alkyl group include alkyl groups, such as a methyl group, an ethyl group, a propyl group, and an isopropyl group, each having 1 to 10 carbon atoms. The number of carbon atoms of the alkyl group is preferably 1 to 8, more preferably 1 to 4, and particularly preferably 1, 2, or 3.

Among nitrogen-containing organic onium cations, in particular, a quaternary ammonium cation and a cation having pyrrolidine, pyridine, or imidazoline serving as a nitrogen-containing heterocyclic skeleton are preferred. In an organic onium cation having a pyrrolidine skeleton, two alkyl groups described above are preferably attached to one nitrogen atom included in the pyrrolidine ring. In an organic onium cation having a pyridine skeleton, one alkyl group described above is preferably attached to one nitrogen atom included in the pyridine ring. In an organic onium cation having an imidazoline skeleton, one alkyl group described above is preferably attached to each of the two nitrogen atoms included in the imidazoline ring.

Specific examples of the organic onium cation having a pyrrolidine skeleton include a 1,1-dimethylpyrrolidinium cation, a 1,1-diethylpyrrolidinium cation, a 1-ethyl-1-methylpyrrolidinium cation, a 1-methyl-1-propylpyrrolidinium cation (MPPY⁺), a 1-butyl-1-methylpyrrolidinium cation (MBPY⁺), and a 1-ethyl-1-propylpyrrolidinium cation. Of these, in particular, pyrrolidinium cations, such as MPPY⁺ and MBPY⁺, each having a methyl group and an alkyl group with 2 to 4 carbon atoms are preferred because of their high electrochemical stability.

Specific examples of the organic onium cation having a pyridine skeleton include 1-alkylpyridinium cations, such as a 1-methylpyridinium cation, a 1-ethylpyridinium cation, and a 1-propylpyridinium cation. Of these, pyridinium cations each having an alkyl group with 1 to 4 carbon atoms are preferred.

Specific examples of the organic onium cation having an imidazoline skeleton include a 1,3-dimethylimidazolium cation, a 1-ethyl-3-methylimidazolium cation (EMI⁺), a 1-methyl-3-propylimidazolium cation, a 1-butyl-3-methylimidazolium cation (BMI⁺), a 1-ethyl-3-propylimidazolium cation, and a 1-butyl-3-ethylimidazolium cation. Of these, imidazolium cations, such as EMI⁺ and BMI⁺, each having a methyl group and an alkyl group with 2 to 4 carbon atoms are preferred.

As the second cation, an alkali metal ion other than a sodium ion, such as a potassium ion, or an organic cation (such as an organic onium cation having a pyrrolidine skeleton or imidazoline skeleton) is preferred.

In the case where the second cation is an organic cation, the melting point of the molten salt electrolyte is easily reduced. However, in the case where the molten salt electrolyte contains an organic cation, the organic cation itself or a decomposition product (such as an ion) of the organic cation may be irreversibly occluded in the hard carbon to reduce the negative electrode capacity. In the foregoing embodiment of the present invention, by setting the reversible capacity ratio Cₙ/Cₚ to the specific range as described above, even if the molten salt electrolyte containing an organic cation is used, a reduction in negative electrode capacity is inhibited, thereby stabilizing the cycle characteristics.

As the second anion, a bis(sulfonyl)amide anion is preferred. The bis(sulfonyl)amide anion may be appropriately selected from the anions exemplified as the first anions.

Specific examples of the second salt include a salt of a potassium ion and FSA⁻ (KFSA), a salt of potassium ion and TFSA⁻ (KTFSA), a salt of MPPY⁺ and FSA⁻ (MPPYFSA), a salt of MPPY⁺ and TFSA⁻ (MPPYTFSA), a salt of EMI⁺ and FSA⁻ (EMIFSA), and a salt of EMI⁺ and TFSA⁻ (EMITFSA). A single type of second salt may be used alone. Two or more types of second salts may be used in combination.

The molar ratio of the first salt to the second salt (=first salt:second salt) may be appropriately selected from the ranges of, for example, 1:99 to 99:1 and preferably 5:95 to 95:5, depending on types of salts. In the case where the second salt is a salt, such as a potassium salt, of an inorganic cation and the second anion, the molar ratio of the first salt to the second salt may be selected from the ranges of, for example, 30:70 to 70:30 and preferably 35:65 to 65:35. In the case where the second salt is a salt of an organic cation and the second anion, the molar ratio of the first salt to the second salt may be selected from the ranges of, for example, 1:99 to 60:40 and preferably 5:95 to 50:50.

The electrolyte used in the sodium molten salt battery may contain a known additive in addition to the foregoing sulfur-containing compound, as needed. Most of the electrolyte is preferably composed of the foregoing molten salts (ionic liquid (specifically, the first salt and the second salt)). The electrolyte has a molten salt content of, for example, 80% by mass or more (e.g., 80% to 100% by mass) and preferably 90% by mass or more (e.g., 90% to 100% by mass). In the case where the molten salt content is within the ranges described above, the heat resistance and/or flame retardancy of the electrolyte is easily enhanced.

The sodium molten salt battery is used in a state in which the positive electrode, the negative electrode, the separator arranged therebetween, and the electrolyte are housed in a battery case. The positive electrode and the negative electrode are stacked or wound with the separator provided therebetween to form an electrode group. The electrode group may be housed in the battery case. In the case where a battery case composed of a metal is used and where one of the positive electrode and the negative electrode is electrically connected to the battery case, part of the battery case may be used as a first external terminal. The remaining one of the positive electrode and the negative electrode is connected to a second external terminal leading to the outside of the battery case with a lead strip or the like in a state of being insulated from the battery case.

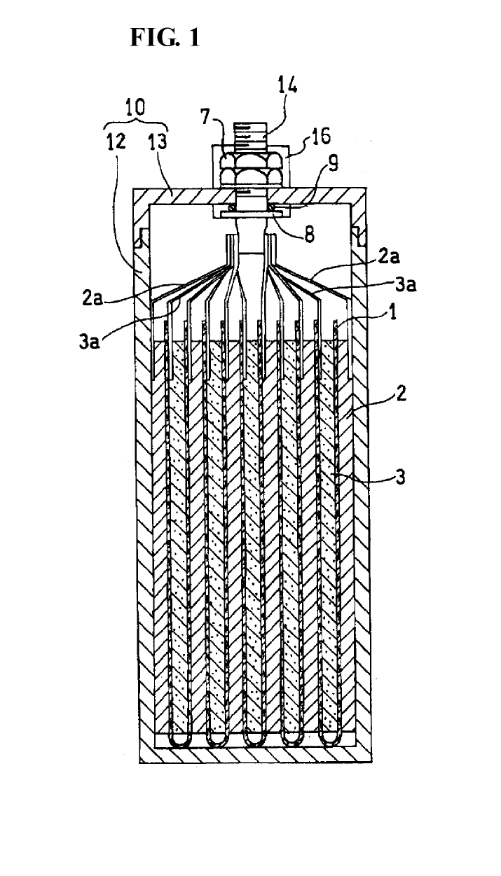

FIG. 1 is a longitudinal sectional view schematically illustrating a sodium molten salt battery.

A sodium molten salt battery includes a stacked electrode group, an electrolyte (not illustrated), and a prismatic aluminum battery case 10 that accommodates these components. The battery case 10 includes a case main body 12 having an open top and a closed bottom; and a lid member 13 that closes the top opening.

When the sodium molten salt battery is assembled, positive electrodes 2 and negative electrodes 3 are stacked with separators 1 provided therebetween to form an electrode group, and the electrode group is inserted into the case main body 12 of the battery case 10. Then a step of filling gaps between the separators 1, the positive electrodes 2, and the negative electrodes 3 constituting the electrode group with an electrolyte is performed by charging a molten salt into the case main body 12. Alternatively, the electrode group may be impregnated with the molten salt, and then the electrode group containing the molten salt may be housed in the case main body 12.

A safety valve 16 configured to release a gas to be generated inside when the internal pressure of the battery case 10 increases is provided in the middle of the lid member 13. An external positive electrode terminal 14 passing through the lid member 13 in a state of being electrically connected to the battery case 10 is provided on one side portion of the lid member 13 with respect to the safety valve 16. An external negative electrode terminal passing through the lid member 13 in a state of being electrically insulated from the battery case 10 is provided on the other side portion of the lid member 13.

The stacked electrode group includes the plural positive electrodes 2, the plural negative electrodes 3, and the plural separators 1 provided therebetween, each of the positive electrodes 2 and the negative electrodes 3 having a rectangular sheet shape. In FIG. 1, each of the separators 1 has a bag shape so as to surround a corresponding one of the positive electrodes 2. However, the shape of each separator is not particularly limited. The plural positive electrodes 2 and the plural negative electrodes 3 are alternately stacked in the stacking direction in the electrode group.

A positive electrode lead strip 2a may be arranged on an end portion of each of the positive electrodes 2. The positive electrode lead strips 2a of the plural positive electrodes 2 are bundled and connected to the external positive electrode terminal 14 provided on the lid member 13 of the battery case 10, so that the plural positive electrodes 2 are connected in parallel. Similarly, a negative electrode lead strip 3a may be arranged on an end portion of each of the negative electrodes 3. The negative electrode lead strips 3a of the plural negative electrodes 3 are bundled and connected to the external negative electrode terminal provided on the lid member 13 of the battery case 10, so that the plural negative electrodes 3 are connected in parallel. The bundle of the positive electrode lead strips 2a and the bundle of the negative electrode lead strips 3a are preferably arranged on left and right sides of one end face of the electrode group with a distance kept between the bundles so as not to come into contact with each other.

Each of the external positive electrode terminal 14 and the external negative electrode terminal is columnar and has a spiral thread at least in the externally exposed portion. A nut 7 is engaged with the spiral thread of each terminal, and is screwed to secure the nut 7 to the lid member 13. A collar portion 8 is arranged in a portion of each terminal inside the battery case. Screwing the nut 7 allows the collar portion 8 to be secured to the inner surface of the lid member 13 with a washer 9.

### APPENDIX

Regarding the foregoing embodiments, the following appendixes are further disclosed.

### Appendix 1

A sodium molten salt battery includes a positive electrode containing a positive electrode active material, a negative electrode containing a negative electrode active material, a separator arranged between the positive electrode and the negative electrode, and a molten salt electrolyte having sodium ion conductivity,

in which the positive electrode active material contains a sodium-containing transition metal oxide,

the negative electrode active material contains hard carbon, and

the ratio of the reversible capacity Cₙ of the negative electrode to the reversible capacity Cₚ of the positive electrode, i.e., Cₙ/Cₚ, is 0.86 to 1.2.

In the sodium molten salt battery, the capacity balance between the positive electrode and the negative electrode is enhanced to inhibit the deposition of metallic sodium particles and inhibit an excessive increase in the irreversible capacity of the hard carbon. Thus, the capacity of the sodium molten salt battery is increased even though the hard carbon is used for the negative electrode.

### Appendix 2

In the sodium molten salt battery described in Appendix 1, preferably, the molten salt electrolyte contains a first salt of a first cation and a first anion and a second salt of a second cation and a second anion in a total amount of 80% by mass or more,
in which the first cation is a sodium ion, and the second cation is an organic cation,
each of the first anion and the second anion is a bis(sulfonyl)amide anion, and
the molar ratio of the first salt to the second salt is 1:99 to 60:40.

The use of the molten salt electrolyte facilitates the inhibition of a reduction in negative electrode capacity. This is advantageous in that the cycle characteristics are stabilized.

### Appendix 3

In the sodium molten salt battery described in Appendix 2, the second cation is preferably an organic onium cation having a pyrrolidine skeleton or an organic onium cation having an imidazoline skeleton. The use of the molten salt electrolyte containing the second cation further stabilizes the cycle characteristics.

### EXAMPLES

The present invention will be specifically described below on the basis of examples and comparative examples. However, the present invention is not limited to these examples described below.

### Example 1

### (1) Production of Positive Electrode

First, 85 parts by mass of NaCrO₂ (positive electrode active material), 10 parts by mass of acetylene black (conductive assistant), and 5 parts by mass of polyvinylidene fluoride (binder) were mixed together with N-methyl-2-pyrrolidone to prepare a positive electrode mixture paste. The resulting positive electrode mixture paste was applied to Al foil, dried, pressed, and vacuum-dried at 150° C. Punching was then performed to produce a disk-shaped positive electrode (diameter: 12 mm, thickness: 85 μm). The weight of the positive electrode active material per unit area of the resulting positive electrode was 13.3 mg/cm². The amount of water in the positive electrode after the vacuum drying was determined by the Karl Fischer method and found to be 100 ppm or less. The reversible capacity of the positive electrode per unit weight of the positive electrode active material was 100 mAh/g.

### (2) Production of Negative Electrode

First, 96 parts by mass of hard carbon (negative electrode active material) and 4 parts by mass of polyamide-imide (binder) were mixed together with N-methyl-2-pyrrolidone to prepare a negative electrode mixture paste. The resulting negative electrode mixture paste was applied to Al foil, dried, pressed, and vacuum-dried at 200° C. Punching was then performed to produce a disk-shaped negative electrode (diameter: 12 mm, thickness: 65 μm). The weight of the negative electrode active material per unit area of the resulting negative electrode was 4.2 mg/cm². The amount of water in the negative electrode after the vacuum drying was determined by the Karl Fischer method and found to be 100 ppm or less.

A half cell was produced with the resulting negative electrode and a metallic sodium electrode (counter electrode). The half cell was fully charged at a constant current of 25 mA/g until a substantially no reduction in the potential of the negative electrode was observed. At this time, the charge capacity of the negative electrode active material per unit weight was determined. The initial capacity of the negative electrode per unit weight of the negative electrode active material was determined from the charge capacity at the first cycle and found to be 350 mAh/g.

Next, the battery was fully discharged at a constant current of 25 mA/g until a substantially no increase in the potential of the negative electrode was observed. At this time, the discharge capacity of the negative electrode active material per unit weight was determined. From the charge capacity at the time of full charge and the discharge capacity at the time of full discharge at the first cycle, the irreversible capacity of the negative electrode active material (the irreversible capacity of the negative electrode active material per unit weight) was determined and found to be 70 mAh/g. The reversible capacity of the negative electrode was calculated by subtracting the value of the reversible capacity from the initial capacity of the negative electrode. The ratio Cₙ/Cₚ was determined from the reversible capacity of the negative electrode, the reversible capacity of the positive electrode, and the weight of the active material of each of the positive electrode and the negative electrode per unit area and found to be 0.9.

### (3) Assembly of Battery

The negative electrode produced in (2) was arranged on the inside bottom portion of a case of a button-type battery. A separator was arranged on the negative electrode. The positive electrode produced in (1) was arranged so as to face the negative electrode with a separator provided therebetween. A molten salt electrolyte was injected into the battery case. A lid member provided with an insulating gasket arranged at its circumference is fitted into an opening portion of the battery case, thereby producing a button-type sodium molten salt battery (battery Al). As the separator, a microporous membrane (thickness: 50 μm) composed of a heat-resistant polyolefin was used. As the molten salt electrolyte, a mixture of NaFSA and MPPYFSA in a molar ratio of 1:9 was used.

### (4) Evaluation

The button-type sodium molten salt battery produced in (3) described above was subjected to constant-current charge at a current rate of 0.2 C to 3.5 V and then constant-voltage charge at 3.5 V. Discharge was performed at a current rate of 0.2 C to 1.5 V. This charge-discharge cycle was repeated 80 times. At each of the first to 80th cycles, the battery capacity during discharging (specifically, the battery capacity per unit weight of the positive electrode active material) was measured.

### Examples 2 to 4 and Comparative Examples 1 and 2

Negative electrodes were produced as in Example 1, except that in (2) of Example 1, the weight of the negative electrode active material per unit area of the negative electrode was changed as listed in Table 1. Sodium molten salt batteries (batteries A2 to A4 and batteries B1 and B2) were produced and evaluated as in Example 1, except that the resulting negative electrodes were used. The Cₙ/Cₚ ratio was determined as in Example 1.

Table 1 lists the weight of the active material per unit area and the Cₙ/Cₚ ratio in the examples and the comparative examples. Batteries Al to A4 were batteries of the examples. Batteries B1 and B2 were batteries of the comparative examples.

TABLE 1

Weight of active material per unit area
(mg/cm²)

| Battery | Positive electrode | Negative electrode | Cₙ/Cₚ |
|---|---|---|---|
| B1 | 13.3 | 3.2 | 0.68 |
| B2 | | 3.8 | 0.8 |
| A1 | | 4.2 | 0.9 |
| A2 | | 4.7 | 1.0 |
| A3 | | 5.0 | 1.06 |
| A4 | | 5.7 | 1.2 |

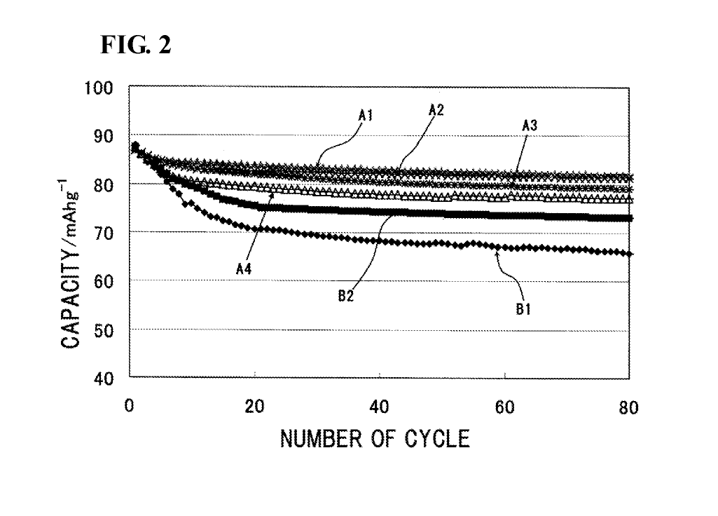

The relationship between the number of charge-discharge cycles for the sodium molten salt batteries of the examples and the comparative examples and the battery capacity per unit weight of the positive electrode active material is illustrated in the graph of FIG. 2. As illustrated in FIG. 2, in batteries B1 and B2 with Cₙ/Cₚ ratios of 0.68 and 0.8, respectively, the battery capacities were reduced as the charge-discharge cycle was repeated. The initial battery capacity was about 87 mAh/g. After the charging and discharging were repeated 80 times, the battery capacities were reduced to 73 mAh/g (battery B2) and 66 mAh/g (battery B1).

In contrast, in each of batteries Al to A4, even after the charging and discharging were repeated 80 times, a high battery capacity more than 75 mAh/g was obtained, and high cycle characteristics was provided. In particular, at a Cₙ/Cₚ ratio less than 1.2, a reduction in battery capacity is small, thus easily resulting in a high battery capacity and easily improving the cycle characteristics.

### INDUSTRIAL APPLICABILITY

According to an embodiment of the present invention, a sodium molten salt battery has a high battery capacity and improved cycle characteristics even though hard carbon is used as a negative electrode active material. Thus, the sodium molten salt battery is useful for, for example, large-scale power storage apparatuses for household and industrial use and power sources for electric vehicles and hybrid vehicles.

### REFERENCE SIGNS LIST

1 separator, 2 positive electrode, 2a positive electrode lead strip, 3 negative electrode, 3a negative electrode lead strip, 7 nut, 8 collar portion, 9 washer, 10 battery case, 12 case main body, 13 lid member, 14 external positive electrode terminal, 16 safety valve

1. A sodium molten salt battery comprising:
a positive electrode containing a positive electrode active material; a negative electrode containing a negative electrode active material; a separator arranged between the positive electrode and the negative electrode; and a molten salt electrolyte having sodium ion conductivity,
wherein the positive electrode active material contains a sodium-containing transition metal oxide,
the negative electrode active material contains hard carbon, and
the ratio of the reversible capacity Cₙ of the negative electrode to the reversible capacity Cₚ of the positive electrode, i.e., Cₙ/Cₚ, is 0.86 to 1.2.

2. The sodium molten salt battery according to claim 1, wherein the molten salt electrolyte contains an ionic liquid in an amount of 80% by mass or more.

3. The sodium molten salt battery according to claim 1, wherein the sodium-containing transition metal oxide is a compound represented by the formula (A):
Na₁₋ₓ₁M¹ₓ₁Cr_{1-y1}M²_{y1}O₂ (A)
(wherein in the formula, M¹ and M² each independently represent at least one selected from the group consisting of Mn, Fe, Co, Ni, and Al, and x1 and y1 satisfy 0≦x1≦⅔ and 0≦y1≦⅔, respectively).

4. The sodium molten salt battery according to claim 1, wherein the sodium-containing transition metal oxide is sodium chromite.

5. The sodium molten salt battery according to claim 1, wherein the average interplanar spacing d₀₀₂ of the (002) planes of the hard carbon measured from an X-ray diffraction spectrum is 0.37 to 0.42 nm.

6. The sodium molten salt battery according to claim 1,
wherein the molten salt electrolyte contains a first salt of a first cation and a firs anion,
the first cation is a sodium cation, and
the first anion is a bis(sulfonyl)amide anion.

7. The sodium molten salt battery according to claim 6,
wherein the molten salt electrolyte further contains a second salt of a second cation and a second anion,
the second cation is a cation other than a sodium ion, and
the second anion is a bis(sulfonyl)amide anion.

8. The sodium molten salt battery according to claim 7, wherein the second cation is an organic cation.
